(19) United States
(12) Patent Application Publication
(10) Pub. No.: US 2024/0073643 A1
(43) Pub. Date: Feb. 29, 2024

(54) METHOD FOR DETERMINING A ROUTE OF A MOBILE TERMINAL FROM DATA RELATING TO A PLURALITY OF NETWORK EVENTS INVOLVING SAID MOBILE TERMINAL, CORRESPONDING DEVICE AND COMPUTER PROGRAM

(71) Applicant: Orange, Issy-Les-Moulineaux (FR)

(72) Inventors: Denis Xavier RENAUD, Chatillon Cedex (FR); Rémy SCHOLLER, Chatillon Cedex (FR); Yunhao CHEN, Chatillon Cedex (FR)

(21) Appl. No.: 18/451,719

(22) Filed: Aug. 17, 2023

(30) Foreign Application Priority Data
Aug. 18, 2022 (FR) 2208381

(51) Int. Cl. H04W 4/02; H04W 16/18

(52) U.S. Cl. CPC H04W 4/026; H04W 16/18

(57) ABSTRACT

There are many techniques for determining the route of a mobile terminal. Among these techniques, some can be used to estimate this route along roads in a transport network using signalling data. Regarding the cross-referencing of this information with transport network graphs to determine this route, it is known to use hidden Markov models (HMMs). When the position of the mobile terminal is obtained using data collected from the radio communication network to which the mobile terminal is attached, the routes taken by a mobile terminal determined using a HMM on the basis of this information are uncertain. The present method and device helps to overcome this limitation by using a likelihood map of support by a base station to calculate a probability of connection of the mobile terminal to a given base station.

### CROSS-REFERENCE TO RELATED APPLICATIONS

This application claims foreign priority to French Patent Application No. FR 2208381, entitled “A METHOD FOR DETERMINING A ROUTE OF A MOBILE TERMINAL FROM DATA RELATING TO A PLURALITY OF NETWORK EVENTS INVOLVING SAID MOBILE TERMINAL, CORRESPONDING DEVICE AND COMPUTER PROGRAM” and filed Aug. 18, 2022, the content of which is incorporated by reference herein in its entirety.

### BACKGROUND

### Field

The field of the development is that of the localisation of mobile objects connected to at least one communication network.

More specifically, the development relates to a method for determining a route taken by a mobile terminal along routes in a transport network by means of collected signalling data and the corresponding devices, computer programs and media.

### Prior Art and its Disadvantages

The signalling data collected by a telecommunications operator within the communication network or networks it operates enables it to identify the use made by its users of the resources it makes available to them. Armed with this knowledge, a telecommunications operator can then plan development and maintenance operations for the equipment that makes up the communications networks it operates, enabling it to meet the needs and expectations of its users.

In recent years, with the development of the Internet of Things (IoT) and the emergence of connected vehicles, telecoms operators have realised that the traffic signalling data in their possession could be of interest to other players and that they were thus becoming an asset to value.

Signalling data from mobile terminals used during travelling is of particular interest for the study of human mobility, for example mobile terminals carried by a user or mobile terminals in a vehicle.

There are a number of techniques for estimating the mobility situation, and more specifically the route, of a mobile terminal. Some of these techniques can be used to estimate a route taken by a mobile terminal along roads in a transport network using signalling data. According to these techniques, the position of the mobile terminal is estimated, approximated by the centre of a coverage area, or cell, of a base station to which the mobile terminal is connected. To do this, use is made of a Voronoi partitioning of the territory covered by the cells making up a radio communication network. With this partitioning, each network event is positioned at the centre of the cell in which it occurs. Such events are time-stamped, enabling a speed and/or movement direction to be calculated based on the coordinates of the centres of the cells. This information is then used in relation to transport network graphs to determine the route taken by the mobile terminal.

However, such techniques have the following limitations specific to Voronoi partitions:
all cells are assumed to be omnidirectional,
the characteristics of the cells (radiation power, height and inclination of the base station antennas) are not taken into account,
the overlap of action zones of the cells is not taken into account,
no location a priori is used.

There are several known approaches to cross-referencing this information with transport network graphs in order to determine the route taken by the mobile terminal.

The probabilistic approach, based on Hidden Markov Models (HMM), which considers the transition between events, is one of the most popular approaches, particularly in location and route-finding applications such as Microsoft Bing Maps, OpenStreetMap and Mapbox.

A hidden Markov model defines hidden states, in this case route segments or nodes in a transport network, and observable states, network events involving a mobile terminal. The idea of such a probabilistic approach is to associate a route segment with each network event involving a mobile terminal using two types of probability: the connection probability (also called the transmission probability in this application) and the transition probability. The connection probability evaluates the probability of the relevant mobile terminal connecting to a cell in a radio communication network, knowing that it is on a given route segment. The transition probability evaluates the probability of transition from the last route segment before a given route segment to the given route segment. Once these probabilities have been obtained, the most likely sequence of route segments is selected as the model output.

Empirically, hidden Markov models assume that the routes closest to a given position of a mobile terminal, or to the position of the base station serving the mobile terminal when the estimation of the mobile terminal's position is uncertain, have greater connection (or transmission) probabilities. In many cases, the spatial position error, which is obtained by means of GPS (Global Positioning System) data, is modelled as a Gaussian distribution with a null mean. Connection (or transmission) probabilities therefore also follow a Gaussian distribution.

For the transition probability, it is often assumed that the distance between two observable states is close to the on-road distance between projections of these two observable states on the road network. The probability of transition is then modelled according to an exponential law as a function of the difference between these two distances.

When the position of the mobile terminal is obtained using data collected from the radio communication network to which the mobile terminal is attached, the routes taken by a mobile terminal determined using hidden Markov models on the basis of this information are highly uncertain. This is partly due to the fact that the cells of a radio communication network sometimes cover large areas, e.g. with a radius of more than 5 km, so the position estimates obtained are very uncertain, and so are the estimates of speed and direction of travel.

There is therefore a need for a solution that does not have all the above disadvantages for identifying a route taken by a mobile terminal along roads of a transport network by means of signalling data.

### SUMMARY

The development responds to this need by proposing a method for determining a route for a mobile terminal from data relating to a plurality of network events involving said mobile terminal, said route consisting of at least one route segment of a transport network.

Such a method is particular in that it comprises:
a determination of at least one candidate route during which it is determined, for at least one first network event from the plurality of network events:

a probability of connection of said mobile terminal to a first base station involved in the first network event, knowing that said mobile terminal is located, at a time t1 at which the first network event occurred, on a first candidate route segment located in a coverage area of the said first base station, also referred to as transmission probability, and

a probability of transition, at a time t2 at which a second network event in which a second base station is involved has occurred, of said terminal to at least one second candidate route segment located in a coverage area of said second base station, knowing that the mobile terminal is on the first candidate route segment at time t1; selection of the said route of said mobile terminal from the set of candidate routes, taking account of the connection probabilities and transition probabilities determined for the plurality of network events.

In the present application, “network event” is understood to mean any event giving rise to a transmission or a reception of signalling data between a mobile terminal and a base station of a communications network, such as the establishment of a communication between the mobile terminal and the base station, for example in the event of an incoming or outgoing call or in the event of the transmission or reception of a short message or SMS, the triggering of a procedure for attachment to the base station, the transmission of a “paging” message to the mobile terminal asking it to wake up from a standby state, etc.

The present solution helps to overcome all or some of the constraints of the state of the art by using a likelihood map of support by a base station to calculate a probability of connection of the mobile terminal to a given base station.

More specifically, such a base station support likelihood map represents the probability of a mobile terminal connecting to a base station at a location within the coverage area of the base station. Such a likelihood map does not correspond directly to a spatial probability density of the presence of the mobile terminal.

Indeed, these likelihood maps supported by a base station is that they have the advantage of taking into account the direction of the cells, their radiation characteristics, the overlap of their action zones unlike some techniques of the state of the art and more particularly to certain techniques using the Voronoi partitions.

More particularly, the first event and the second event are selected from a plurality of network events involving the mobile terminal and occurring during a first time window. In some embodiments, the first event and the second event are two consecutive events.

This makes it possible to estimate the mobility conditions of a mobile terminal over a short time window in the order of one or more tens of minutes, for example less than or equal to 15 minutes, which is not the case with the techniques in the state of the art, which have difficulty extracting relevant information over short time windows because of their poor recognition of the uncertainties in locating mobile terminals. In addition, this makes the present solution compatible with legislative provisions relating to the retention of event logs relating to mobile terminals, which limit the length of the log retention period (for example, a retention period of around 15 minutes), unlike certain solutions in the state of the art.

The present solution proposes to use a sequence of mobility data relating to a mobile terminal in association with one or more transport network graphs, e.g. road or motorway network, rail network, metropolitan network, etc., in order to determine a route taken by the mobile terminal. To achieve this, the present solution implements a hidden Markov model in which the observed states correspond to data relating to network events involving the mobile terminal and the hidden states correspond to the route segments of the transport network graphs. In other words, the proposed solution is adapted to the spatial uncertainty of a radio communication network and the sporadic nature of the data relating to network events.

In some embodiments, the route selected is that for which the product of the set of connection (transmission) probabilities with the set of transition probabilities previously determined is the highest.

In some embodiments, the connection (or transmission) probability P (A|s₁) for a given network event is determined according to the following formula:

$$P ( A \vert {s}_{1} ) = \frac{{\sum }_{j = 1}^{n} P ( A \vert {p}_{j} )}{n}$$

in which A represents the first base station involved in the first event, s₁ represents the first candidate route segment located within the coverage area of said first base station, pⱼ represents a pixel of a likelihood map representing a probability of connection of said mobile terminal to the first base station when the terminal is located on a pixel of said likelihood map, and n represents the number of pixels of said likelihood map of non-null weight crossed by the first candidate route segment s₁.

This connection (or transmission) probability is determined on the basis of mobile terminal location data that is more accurate and more relevant than certain solutions of the state of the art.

In some embodiments, a selection of said at least one first candidate route segment by taking into account a distance between said at least one first candidate route segment and at least one candidate route segment at a time t0 prior to time t1.

More particularly, in some embodiments, the first candidate route segment is selected among the route segments located at a distance less than or equal to a first distance, so-called connectivity tolerance distance, from all the candidate route segments at a time t0 prior to time t1.

In some embodiments, the value of the first connectivity tolerance distance may take into account a geographic distribution density of base stations and a median radius of a base station coverage area in the vicinity of said first base station.

In some embodiments, the method may comprise a step of selecting the first candidate route segment comprising:
a determination of a convex envelope constituted by all the candidate route segments at a time t0 prior to time t1,
a selection of said at least one first candidate route segment located at a distance less than or equal to a first threshold, known as the connectivity tolerance threshold.

This can help, at least in some embodiments, to reduce the number of candidate route segments and thus reduce the computing time and/or computing power required.

In some embodiments, the value of the connectivity tolerance threshold is the product of a weighting coefficient representative of a geographical distribution density of the base stations with a median radius of a base station coverage area knowing a radius of a coverage area of at least one base station located at a temporal distance from said first base station less than or equal to a second threshold.

Thus, the lower the density of base stations and therefore the greater the distance between them, as is the case in the countryside, the greater the weighting coefficient. Conversely, the higher the density of base stations and the closer they are to each other, as is the case in urban areas, the lower the weighting coefficient.

In some embodiments, the probability of connection (or transmission) is weighted using a penalty coefficient representative of a deviation of a direction of the first candidate route segment from a reference direction, the penalty coefficient tending towards zero as the deviation between the direction of the first candidate route segment and the reference direction increases.

This can help, at least in some embodiments, to favour candidate route segments with the smallest deviation from a reference direction.

In some embodiments, the transition probability P(s₂|s₁) for a given network event is determined according to the following formula:

P(s₂/51 s₁)=∫_{d}_{ₘᵢₙ} ^{d}^{ₘₐₓ}f(u)du
in which: s₁ represents the first candidate route segment within the coverage area of said first base station, s₂ represents the second candidate route segment within the coverage area of said second base station, f (u) represents a distance distribution density between the coverage areas of the first base station and the second base station, dₘᵢₙ represents the minimum distance separating the first candidate route segment and the second candidate route segment on a graph representing said transport network, and dₘₐₓ represents the sum of dₘᵢₙ with the length of the first candidate route segment and the length of the second candidate route segment.

According to this aspect of the present method, the transition probability is determined by taking into account a distribution density of distances between the coverage areas of the first base station and the second base station. At least in some embodiments, this choice can help to take account of the uncertainty of movement of the mobile terminal inherent in the radio communication network. Uncertainty about the location of the cells in a radio communications network can, in some cases, lead to uncertainty about the distance travelled by a mobile terminal within this radio communications network.

Thus, this distance distribution density relates in other words to actual movements of the mobile terminal. This corresponds to a situation in which the mobile terminal has changed its home base station following an (actual) move, excluding situations in which the mobile terminal has not left the coverage area of a base station and is therefore immobile from the point of view of the radio communications network.

In some embodiments, the transition probability P(s₂/51 s₁) for a given network event is determined according to the following formula:

P(s₂/51 s₁)=∫_{ν}_{ₘᵢₙ} ^{ν}^{ₘₐₓ}f(ν)dν
in which s₁ represents the first candidate route segment within the coverage area of said first base station, s₂ represents the second candidate route segment within the coverage area of said second base station, f(ν) represents an average speed density of movement of the mobile terminal, νₘᵢₙ =dₘᵢₙ/Δt where dₘᵢₙ represents the minimum distance separating the first candidate route segment and the second candidate route segment on a graph representing said transport network and νₘₐₓ=dₘₐₓ/Δt where dₘₐₓ represents the sum of d min with the length of the first candidate route segment and the length of the second candidate route segment and where Δt=t2−t1.

In some embodiments, the transition probability P(s₂/51 s₁) for a given network event is determined according to the following formula:

P(s₂/51 s₁)=∫_{θ}_{ₘᵢₙ} ^{θ}^{ₘₐₓ}f(θ)dθ
in which s₁ represents the first candidate route segment within the coverage area of said first base station, s₂ represents the second candidate route segment within the coverage area of said second base station, f (θ) represents an average direction density of movement of the mobile terminal between the coverage areas of the first base station and the second base station, θₘᵢₙ represents the infimum of an intersection of a first angular sector defining possible directions of movement for the mobile terminal with a second angular sector defining a maximum angle between a first end of the first candidate route segment and a second end of the second candidate route segment, and θₘₐₓ represents the supremum of the intersection of the first angular sector and the second angular sector.

In some embodiments, the transition probability is determined as a function of at least two densities representative of a movement of the mobile terminal from among the distribution density of distances between the coverage areas of the first base station and the second base station f (u), the average movement speed density of the mobile terminal f (ν) and the average movement direction of the mobile terminal between the coverage areas of the first base station and the second base station f (θ).

This can help, at least in some embodiments, to improve the determination of the route taken by the mobile terminal since the data provided as input to the hidden Markov model takes into account many aspects of the movement of a mobile terminal such as its speed of movement as well as the direction of this movement and the distance travelled.

In some embodiments, the transition probability is weighted according to the number of intersections of route segments of the transport network encountered along the candidate route.

In some embodiments, the transition probability is weighted by a penalty coefficient representative of a number of intersections of route segments of the transport network encountered along the candidate route, the penalty coefficient tending towards zero as the number of intersections increases.

This can help, at least in some embodiments, to favour transitions between candidate route segments involving as few nodes as possible.

The purpose of the development is also a device capable of determining a route taken by a mobile terminal from data relating to a plurality of network events involving said mobile terminal, said route being constituted of at least one route segment of a transport network graph.

Such a device is particular in that it comprises at least one processor configured for:
determining at least one candidate route by determining, for at least one first network event from the plurality of network events:
   a probability of connection of said mobile terminal to a first base station involved in the first network event, knowing that said mobile terminal is located, at a time t1 at which the first network event occurred, on a first candidate route segment located in a coverage area of the said first base station, also referred to as transmission probability, and
   a probability of transition, at a time t2 at which a second network event in which a second base station is involved has occurred, of said terminal to at least one second candidate route segment located in a coverage area of said second base station, knowing that the mobile terminal is on the first candidate route segment at time t1;
select said route taken from the set of candidate routes, said route taken being the one for which a product of the set of connection probabilities with the set of transition probabilities determined for the plurality of network events is the highest.

Such a device, suitable for implementing the method of the development in any of its embodiments or according to any combination of the embodiments described in this document, may, for example, be embedded in a server belonging to the telecommunications operator operating the radio communications network to which the base stations belong.

The development also relates to a computer program product comprising program code instructions for implementing a method as described previously, according to any one of its embodiments, when it is executed by a processor.

The development also relates to a computer-readable storage medium on which is saved a computer program comprising program code instructions for implementing the steps of the method according to the development as described above according to any one of its embodiments.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the method of the above-mentioned development.

### BRIEF DESCIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows a diagram of the steps of a method for determining a route taken by a mobile terminal from data relating to a plurality of network events involving said mobile terminal;

FIG. 2A: this figure shows an example of a likelihood map of support by a cell associated with the base station, obtained with an a priori of uniform mobile presence;

FIG. 2B: this figure shows an example of a likelihood map of support by a cell obtained with an a priori presence of the mobile along a road and a high-speed train line;

FIG. 3: this figure illustrates the concept of the radius of action of a base

station;

FIG. 4: this figure shows the sequence of steps leading to a distance distribution density between the coverage areas of a first base station A₁ and a second base station A₂;

FIG. 5: this figure shows the sequence of steps leading to obtaining an average speed density for movement of the mobile terminal;

FIG. 6: this figure represents the sequence of steps leading to obtaining an average direction density of movement of the mobile terminal between the coverage areas of the first base station A₁ and the second base station A₂;

FIG. 7A: this figure shows a situation in which the mobile terminal is stationary from the point of view of the radio communications network;

FIG. 7B: this figure shows a situation in which the mobile terminal is mobile from the point of view of the radio communications network;

FIG. 8: this figure shows a device capable of implementing certain steps of the solution described above.

### DETAILED DESCRIPTION OF CERTAIN ILLUSTRATIVE EMBODIMENTS

The general principle of the development is based on the use of signalling data collected by a telecommunications operator operating at least one radio communications network to determine a route taken by a mobile terminal along the routes of one or more transport networks. More particularly, in at least some of the detailed embodiments, one element of the signalling data used in the present solution may be a base station support likelihood map. As already explained above (“summary” section), such a likelihood map represents the probability of a mobile terminal connecting to a base station at a location within the coverage area of the base station. Thus, in at least some embodiments of the present method, the use of a likelihood map can help to improve the results obtained, compared with the solutions of the prior art, in terms, for example, of reliability, accuracy and/or realism.

Such knowledge can also help, for example, in a better classification of the different types of goods vehicles and their uses, a better management of the fleets of bicycles or scooters made available to the public, a better tracking of postal parcels equipped with connected trackers, and/or a better planning of the flow of passengers on public transport, etc.

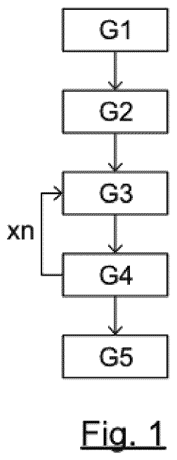

FIG. 1 shows a diagram of the steps of a method for determining a route taken by a mobile terminal from data relating to a plurality of network events involving said mobile terminal.

Such a method is based on the implementation of a hidden Markov chain. The present solution thus consisting in using a sequence of mobility data relating to a mobile terminal in association with one or more transport network graphs, e.g. road or motorway network, rail network, metropolitan network, etc., in order to determine a route taken by the mobile terminal. To achieve this, the method implements a hidden Markov model in which the observed states correspond to data relating to network events involving the mobile terminal and the hidden states correspond to the route segments of the transport network graphs.

In a step G1, signalling data is collected, for example by means of probes placed in a radio communication network. This signalling data is then stored in one or more databases. In such a database, each entry corresponds, for example, to a network event.

In the detailed embodiments, the signalling data collected for a network event includes, but is not limited to:
a mobile terminal identifier (e.g. a pseudonym uniquely identifying the mobile terminal to the operator),
timestamp data for the occurrence of the network event,
an identifier for the base station or cell that is associated with the network event.

In the detailed embodiments, enhanced signalling data can also be stored in the database. In this way, a network event can also be associated with a support likelihood map for the cell associated with the base station with which the mobile terminal interacted during the occurrence of the network event.

A likelihood map for support by a cell associated with a base station, for example, can be obtained by simulation. Knowing that the coverage area of a base station is constituted by a plurality of cells, a plurality of support likelihood maps can be associated with a same base station. For example, for a base station comprising an antenna Aᵢ, a support likelihood map can represent a connection probability P (Aᵢ|(X, Y) ∈ pₖ) of the mobile terminal to the antenna Aᵢ (where pₖ is one of the map's pixels), at the coordinate point (X, Y) knowing that the mobile terminal is located on the pixel pₖ.

Since the geographic map representing the coverage area of the base station is partitioned into pixels, the total probability formula can be used to obtain the probability of a mobile terminal being located on the pixel pₖ knowing that it is connected to the antenna Aᵢ of the base station:

$$P ( ( X , Y ) ∈ {p}_{k} \vert {A}_{i} ) = \frac{P ( ( X , Y ) ∈ {p}_{k} ) P ( {A}_{i} \vert ( X , Y ) ∈ {p}_{k} )}{P ( {A}_{i} )} = \frac{P ( ( X , Y ) ∈ {p}_{k} ) P ( {A}_{i} \vert ( X , Y ) ∈ {p}_{k} )}{{\sum }_{{k}^{′}} P ( ( X , Y ) ∈ {p}_{{k}^{′}} ) P ( {A}_{i} \vert ( X , Y ) ∈ {p}_{{k}^{′}} )}$$

which is equivalent, by noting P ((X, Y) ∈ pₖ)=Prior(k) the a priori presence of the mobile on the pixel pₖ, to

$$P ( ( X , Y ) ∈ {p}_{k} \vert {A}_{i} ) = \frac{Prior ( k ) P ( {A}_{i} \vert ( X , Y ) ∈ {p}_{k} )}{{\sum }_{{k}^{′}} Prior ( {k}^{′} ) P ( {A}_{i} \vert ( X , Y ) ∈ {p}_{{k}^{′}} )} .$$

From these probabilities and by choosing an a priori presence of the mobile terminal, we obtain a spatial density map of presence.

Such an a priori can be chosen, for example, from a uniform presence, a presence along main roads, and/or a presence as a function of population density, etc. Such a geographical map representative of the coverage area of the base station is obtained, for example, by simulations. The a priori presence of the chosen mobile may depend on the population of mobile terminals that are wanted to be monitored. According to a first example, an a priori presence of the mobile can be chosen when it is wanted to determine the distance travelled over the entire coverage area of the base station. According to a second example, an a priori presence along roads can be chosen if it is wanted to determine the distance travelled by mobile terminals onboard vehicles. According to a third example, an a priori presence can be selected as a function of population density if it is wanted to monitor the movement of mobile terminals in living areas.

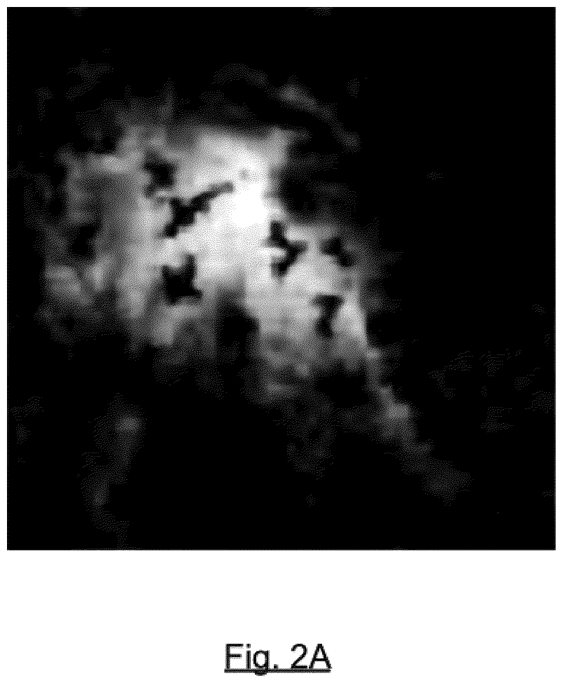

An example of a likelihood map of support by a cell associated with the base station obtained with an a priori of uniform presence of the mobile is shown in FIG. 2A.

Another example of a likelihood map of support by a cell obtained with an a priori presence of the mobile along a road and a high-speed train line is shown in FIG. 2B.

In some embodiments, an event can also be associated, in the database, with a value of a radius of action of an antenna of the corresponding base station. This radius of action can be expressed in metres, for example. This radius of action can be from a few dozen metres to several hundred metres.

Thus, for a cell of a base station (for example each cell of the base station), it may be possible to define a radius of action R such that the probability of the presence of a mobile terminal in a disc of radius R around the centre of this cell knowing that the probability of the occurrence of a network event at a given time is greater than or equal to a first probability (such as 85% in the detailed example). Such a network event is, for example, a connection of a mobile terminal to an antenna of the base station serving the relevant cell at a given time.

The radius of action R may, for example, depend on the technology used (according to whether it complies with 2^{nd}, 3^{rd}, 4^{th} (LTE) or 5^{th} generation telecommunications standards) and/or the type of geographic area concerned, e.g. rural, urban or suburban.

In other words, for an antenna Aᵢ whose coordinates on the geographic map are (xᵢ, yᵢ), having a radius of action Rᵢ, and noting D_{R}_{ᵢ} the disc of radius Rᵢ centred on the centre of the cell in question, there is:
P (X, Y) ∈ D_{R}_{ᵢ}|Aᵢ)≥85% noting (X, Y) the pair of random variables giving the position of the mobile terminal at time tᵢ.

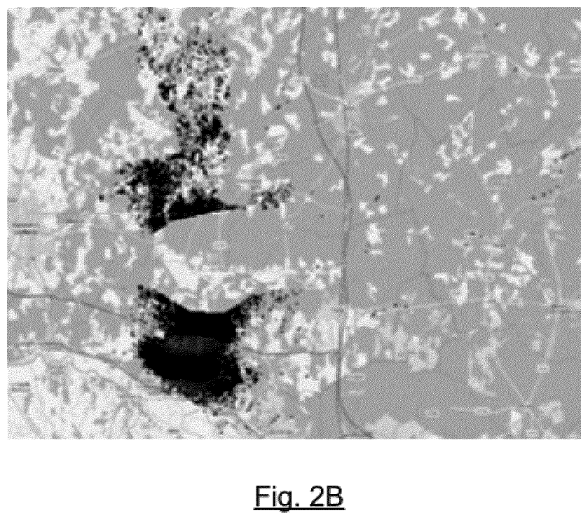

FIG. 3 illustrates this notion of radius of action.

This method is based on the use of signalling data relating to mobile terminals, and therefore to their users. Also, in certain implementation modes, its use must comply with regulatory data anonymisation and/or pseudonymisation constraints. In addition, these constraints can sometimes impose (relatively short) deadlines for data anonymisation and/or pseudonymisation. In some embodiments, the calculations to be performed use signalling data whose history (i.e. conservation) must not exceed a certain duration. This duration, or time window, may be one or several tens of minutes depending on the design, for example 15 minutes. The calculations themselves must therefore be carried out in a time shorter than such time.

In step G2, one or more transport network graphs, such as maps of road or motorway networks, rail networks, metropolitan networks, etc. corresponding to a geographic area in which the mobile terminal has moved are obtained.

In a step G3, a connection (or transmission) probability P(A₁|s₁) for a first network event E1 is determined using the following formula:

$$P ( {A}_{1} \vert {s}_{1} ) = \frac{{\sum }_{j = 1}^{n} P ( A \vert {p}_{j} )}{n}$$

in which A₁ represents the first base station involved in the first event E1, s₁ represents a candidate route segment located within the coverage area of the base station A₁, pⱼ represents a pixel of a likelihood map representing a probability of connection of said mobile terminal to the base station A₁ when the terminal is located on a pixel of this likelihood map, and n represents the number of pixels of said likelihood map of non-null weight crossed by the candidate s₁ route segment. Such a candidate route segment s₁ is, for example, a section of road or motorway, a section between two underground stations, etc.

In other words, P(A₁|s₁) represents the average of the connection probabilities of the mobile terminal to the base station A₁ knowing that the mobile terminal is located, at time t1 at which the network event E1 occurred, on a pixel of the likelihood map crossed by the candidate route segment s₁

In some embodiments, in order to reduce calculation time, prior to calculating the connection (or transmission) probability P(A₁|s₁), candidate route segments sᵢ can be selected.

To do this, initially, a convex envelope constituted by a set of candidate route segments is determined at a time t0 prior to time t1.

Secondly, a value of a connectivity tolerance threshold STC is calculated, for example as the product of a weighting coefficient co representative of a geographic distribution density of the base stations with a median radius of a base station coverage area knowing the radius of a coverage zone of at least one base station located at a temporal distance δ from the base station considered less than or equal to a second threshold S. A value of δ allowing a relevant value of the connectivity tolerance threshold STC to be determined is for example 15 minutes.

So the lower the density of base stations and therefore the greater the distance between them, as is the case in the countryside, the greater the weighting coefficient ω. Conversely, the higher the density of base stations and the closer they are to each other, as is the case in urban areas, the lower the weighting coefficient ω.

The candidate route segments selected for the network event E1 are the set of candidate route segments located at a distance from the connected envelope constituted by all the candidate route segments at time t0 which is less than or equal to a first connectivity tolerance distance STC.

In order to improve the accuracy of the calculation of the connection (or transmission) probability, the connection probability can be weighted using a penalty coefficient representative of a deviation of a direction of a candidate route segment sᵢ from a reference direction θ_{model}, the penalty coefficient tending towards zero as the deviation between the direction of the candidate route segment sᵢ considered and the reference direction θ_{model} increases.

By way of example, the mathematical law linking the value of the penalty coefficient with the value of the deviation between the direction of the candidate route segment sᵢ considered and the reference direction θ_{model} is given by the following formula:

y=λe^{-λx}
where y corresponds to the value of the penalty coefficient, x to the value of the deviation between the direction of the candidate route segment sᵢ considered divided by an angle of 45° and the reference direction θ_{model} and λ a constant. In the remainder of this document, it is assumed that λ is 1. Naturally, A can take other values depending on the case in question. The angle can also be set at a value other than 45°. The value of the angle can be chosen so that the value of the member e^{-λx} does not fall abruptly as the deviation increases. The result is improved performance.

In order to further reduce the number of candidate route segments for a given network event E1, once a connection (or transmission) probability has been calculated for each of the candidate route segments, they can be ordered in order of increasing connection probabilities. The n candidate route segments with the highest connection probabilities are then selected. For example, the number n can be determined arbitrarily by applying the following formula:

n=max(15, ceil(n1/n2))
where n1 is the number of candidate route segments for network event E1, the number n2 is chosen arbitrarily, ceil is the function that rounds up to the higher number. The choice of the value of the number n2, here 10 for example, has an impact on the performance obtained. Hence, depending on the situation, a value other than 10, smaller or larger, can help to improve performance.

At the end of step G3, a connection (or transmission) probability has been calculated for all the candidate route segments for a given network event.

In a step G4, a transition probability P(s₂/51 s₁) between a first candidate route segment corresponding to a first network event E1 and a second candidate route segment corresponding to a second network event E2 occurring at a time t2 and involving a second base station A₂ is determined.

In a first implementation, the transition probability P (s₂/51 s₁) is determined as follows:

P(s₂/51 s₁)=∫_{d}_{ₘᵢₙ}^{d}^{ₘₐₓ}f(u)du
in which s₁ represents the candidate route segment s₁ being located within the coverage area of the base station A₁, s₂ represents the second candidate route segment being located within the coverage area of the base station A₂, f (u) represents a distance distribution density between the coverage areas of the first base station A₁ and the second base station A₂, dₘᵢₙ represents the minimum on-route distance separating the candidate route segment s₁ and the second candidate route segment s₂ and dₘₐₓ represents the sum of dₘᵢₙ with the length of the first candidate route segment s₁ and the second candidate route segment length s₂. In other words, dₘₐₓ represents the maximum on-route distance separating the first candidate route segment s₁ and the second candidate route segment.

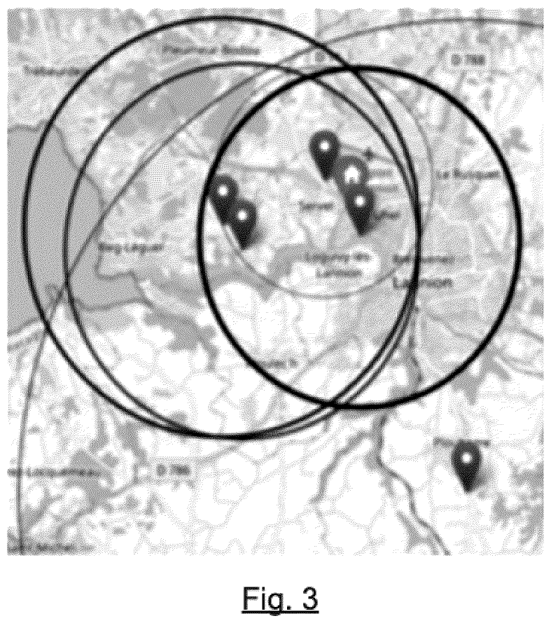

Such a distribution density of distances between the coverage areas of the first base station A₁ and the second base station A₂, f (u) is obtained as follows with reference to FIG. 4.

In a first step E1, a first network event ER1 and a second network event ER2 are selected from a plurality of network events ERᵢ involving the mobile terminal. Such a selection consists in taking all the pairs of network events such that the two network events ER1 and ER2 constituting a pair of network events are present in the time window considered, that they are separated by a duration at least equal to a certain duration (known as the minimum), for example 5 minutes, and are such that the network event ER2 is later than the network event ER1.

The first and second network events ER1, ER2 occur respectively at times t 1 and t 2 and involve the antennas A₁ and A₂ carried by two base stations which may be either different or the same.

For i ∈ {1, 2} we denote (Xᵢ, Yᵢ) the random variables respectively giving the longitude and latitude of the mobile terminal at time tᵢ.

In the rest of the document, the following assumptions are made:
the random variables (Xᵢ, Yᵢ) associated with the probability densities of the presence of the two antennas A₁ and A₂ are independent,
the movement of the mobile terminal is assumed to be uniformly rectilinear if the time between two events is less than a first duration (for example a constant duration acting as a minimum threshold).

In a step E2, a distance density f_{D}_{₁₂} is determined for two network events ER1 and ER2 belonging to the first set of network events JER1 Using the total probability formula and the hypotheses mentioned above, it can be proved that the random variables (Xᵢ, Yᵢ) follow a density law fᵢ. Naturally, other calculation methods can be used to obtain the distance density f_{D}_{₁₂}.

It is then posed D₁₂=√(X₂−X₁)²+(Y₂−Y₁)² where D₁₂ is the random variable giving the distance travelled by the mobile terminal between the times t₁ and t₂.

The random variable D₁₂ follows a density law f_{D}_{₁₂}, such that: ∀ d ∈ [symbol] ₊:

$${f}_{{D}_{12}} ( d ) = {\int }_{{ℝ}^{3}} {f}_{1} ( {x}_{1} , {y}_{1} ) {\sum }_{\pm } {f}_{2} ( {x}_{2} , {y}_{1} \pm \sqrt{{d}^{2} - {( {x}_{2} - {x}_{1} )}^{2}} ) \frac{d {\{ d > \vert {x}_{2} - {x}_{1} \vert \}}_{} ( {x}_{1} , {x}_{2} , d )}{\sqrt{{d}^{2} - {( {x}_{2} - {x}_{1} )}^{2}}} d {x}_{1} d {x}_{2} d {y}_{1} \qquad ( 1 )$$

By integrating this density over a distance interval [dₐ, d_{b}] included in [symbol] and noting E(dₐ, d_{b})={(x, y, x′, y′)∈ [symbol] ⁴/|y′−y|≤√d_{b}²−9x′−x)²et dₐ≤|x′−x|≤d_{b}}, it is obtained, after inversion and with the help of changes of variables y₂=y₁±√d²−(x₂−x₁)² in the appropriate integrals, we obtain a form that is much more convenient for numerical calculation:

∫_{d}_{ₐ}^{d}^{_{b}}f_{D}_{₁₂}(d)= [symbol] f₁(x₁, y₁) [symbol] _{E(d}_{ₐ}_{,d}_{_{b}}⁾(x₁, x₂, y₁, y₂)dx₁dx₂dy₁dy₂ (2)

A method of calculating this distance density f_{D}_{₁₂} can, in some embodiments, involve creating a spatial mesh of the two geographical maps representative of a coverage zone of a base station associated with an antenna Aᵢ, a first geographical map corresponding to the base station involved in the network event ER1 and a second geographical map corresponding to the base station involved in the network event ER2. Each pixel pₖ of this mesh can be associated with a support probability by the antenna Ai conditioned by the presence of the mobile terminal at this pixel P (Aᵢ|(X, Y) ∈ pₖ). Such information is provided, for example, by the likelihood map of support by a cell associated with the antenna Aᵢ.

In a second implementation, the transition probability P(s₂|s₁) is determined as follows:

P(s₂|s₁)=∫_{ν}_{ₘᵢₙ} ^{ν}^{ₘₐₓ}f(ν)dν
in which s₁ represents the first candidate route segment being located within the coverage area of said first base station A₁, s₂ represents the second candidate route segment being located within the coverage area of said second base station A₂, f (ν) represents an average speed density of movement of the mobile terminal, νₘᵢₙ=dₘᵢₙ/Δt where dₘᵢₙ represents the minimum on-route distance separating the first candidate route segment s₁ and the second candidate route segment s₂ and νₘₐₓ=dₘₐₓ/Δt where dₘₐₓ represents the sum of dₘᵢₙ with the length of the first candidate route segment and the length of the second candidate route segment and where Δt=t2−t1.

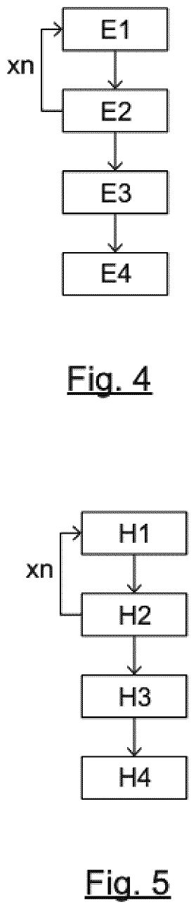

Referring to FIG. 5, in a step H1, a first network event ER1 and a second network event ER2 are selected from a plurality of network events ER, involving the mobile terminal. Such a selection consists in taking all the pairs of network events such that the two network events ER1 and ER2 constituting a pair of network events are present in the time window considered, that they are separated by a duration at least equal to a certain duration (known as the minimum), which can be set to be in the order of a few seconds to a few minutes, for example 5 or 6 minutes, and are such that the network event ER2 is later than the network event ER1.

The first and second network events ER1, ER2 occur respectively at times t₁ and t₂ and involve the antennas A₁ and A₂ carried by two base stations which may be different or the same.

For i ∈ {1, 2} we denote (Xᵢ, Yᵢ) the random variables respectively giving the longitude and latitude of the mobile terminal at time tᵢ.

In the rest of the document, the following assumptions are made:
the random variables (Xᵢ, Yᵢ) associated with the probability densities of the presence of the two antennas A₁ and A₂ are independent,
the movement of the mobile terminal is assumed to be uniformly rectilinear if the time between two events is less than a first duration (for example a constant duration acting as a minimum threshold).

In a step H2, a distance density f_{D}_{₁₂}, is determined. By using the total probability formula and the hypotheses mentioned above, it can be proved that a pair of variables (Xᵢ, Yᵢ) follows a density law fᵢ. Naturally, other calculation methods can be used to obtain the distance density f_{D}_{₁₂}.

It is then posed D₁₂=\sqrt{(X₂−X₁)²+(Y₂−Y₁)²} where D₁₂ is the random variable giving the distance travelled by the mobile terminal between the times t₁ and t₂.

The random variable D₁₂ follows a density law f_{D}_{₁₂}, such that: ∀ d ∈ [symbol] ₊:

$${f}_{{D}_{12}} ( d ) = {\int }_{{ℝ}^{3}} {f}_{1} ( {x}_{1} , {y}_{1} ) {\sum }_{\pm } {f}_{2} ( {x}_{2} , {y}_{1} \pm \sqrt{{d}^{2} - {( {x}_{2} - {x}_{1} )}^{2}} ) \frac{d {\{ d > \vert {x}_{2} - {x}_{1} \vert \}}_{} ( {x}_{1} , {x}_{2} , d )}{\sqrt{{d}^{2} - {( {x}_{2} - {x}_{1} )}^{2}}} d {x}_{1} d {x}_{2} d {y}_{1}$$

Since the mobile terminal is assumed to move in a uniform rectilinear motion, a velocity density is calculated using the following change of variable

$$v = \frac{d}{{t}_{2} - {t}_{1}} ,$$

which gives:

f_{V}_{₁₂}(ν)=(t₂−t₁)f_{D}_{₁₂}(d)

By integrating this density over a distance interval [dₐ, d_{b}] included in [symbol] and noting E(dₐ, d_{b})={(x, y, x′, y′)∈ [symbol] ⁴/|y′−y|≤\sqrt{d_{b}²−(x′−x)²} et dₐ≤|x′−x|≤d_{b}}, it is obtained, after inversion and with the help of changes of variables y₂=y₁±\sqrt{d²−(x₂−x₁)²} in the appropriate integrals, we obtain a form that is much more convenient for numerical calculation:

∫_{d}_{ₐ}^{d}^{_{b}}f_{D}_{₁₂}(d)= [symbol] f₁(x₁, y₁) [symbol] _{E(d}_{ₐ}_{,d}_{_{b}}⁾(x₁, x₂, y₁, y₂)dx₁dx₂dy₁dy₂ (2)

One method for calculating this distance density f_{D}_{₁₂} can be to create a spatial mesh of two geographic maps representing a coverage area of a base station associated with an antenna Aᵢ. Each pixel pₖ of this mesh can be associated with a support probability by the antenna Aᵢ conditioned by the presence of the mobile terminal at this pixel P(Aᵢ|(X,Y) ∈ pₖ). Such information is provided, for example, by the likelihood map of support by a cell associated with the antenna Aᵢ.

Hence, in some embodiments, at the end of a step H2, a distance density f_{D}_{₁₂} can be obtained and, therefore, by means of the change of variable

$$v = \frac{d}{{t}_{2} - {t}_{1}} ,$$

a speed density can be obtained for a pair of network events ER1, ER2.

In order to improve the accuracy of the value of the mobile terminal movement speed, steps H1 and H2 can be repeated, in some embodiments, for a plurality of pairs of events (on the condition, for example, that the times tᵢ associated with each event fall within the historical time window (of 15 minutes, for example) defined above). Naturally, the length of the time window can take on any other value depending on requirements, legislation, etc.

Hence, once all the pairs of events ER;, ERS within the time window have been formed, steps H1 and H2 are carried out for each of these pairs of events ERᵢ, ERⱼ. At the end of these various iterations of steps H1 and H2, it is possible to obtain as many mobile terminal movement speed densities as there are pairs of events ERᵢ, ERⱼ.

In some embodiments, a step H3 in which a combination of the different mobile terminal movement speed densities obtained can be implemented. Such a combination may, for example, result in a probability density for the average movement speed of the mobile terminal for a duration less than or equal to that of the time window considered.

Such embodiments may, for example, be based on at least one additional assumption. Hence, it can be assumed that there is a speed law relating to the movement of the mobile terminal. For example, it can be assumed that this speed law relating to the movement of the mobile terminal can be obtained from the different movement speed densities of the mobile terminal corresponding to the pairs of events ERᵢ, ERⱼ.

In the detailed embodiments, to obtain the probability density of the average movement speed of the mobile terminal over the duration of the time window considered, it is possible, for example, to consider two pairs of events, a first pair of events C₁ constituted by events ER1 and ER2 and a second pair of events C₂ constituted by events ER3 and ER4, as well as the corresponding movement speed densities of the mobile terminal obtained at the end of the implementation of steps E1 and E2, and noted respectively V₁ and V₂.

Note V the random variable representing the average movement speed density of the mobile terminal, which it is sought to be obtained from the movement speed densities of the mobile terminal V₁ and V₂.

Knowing the following property:

∀(v, v′)∈ [symbol] ₊², P(V ∈ [v, v′])>0⇔P(V₁ ∈ [v,v′])>0) et P(V₂ ∈ [v, v′])>0) (3)
which says that for the event, in the sense of probabilities, “V ∈ [v, v′]” occurs with a non-null probability, it is necessary and sufficient that the events, in the sense of probabilities, “Vᵢ∈ [v, v′]” occur with a non-null probability.

By noting that the movement speed densities of the mobile terminal V₁ and V₂ are independent of each other by construction, property (3) can then be rewritten as:

∀(v, v′)∈ [symbol] ₊², P(V ∈ [v, v′])>0⇔P(V₁0∩V₂>0)>0 (3′)

If we consider the average speed density of the mobile terminal V verifying equation (3′) as the result of two random experiments whose order does not matter, it is then possible to write, by noting I_{v, v′}=[v, v′] for all v, v′:

$$P ( V ∈ {I}_{v , {v}^{′}} ) = P ( {V}_{1} , {V}_{2} ∈ {I}_{v , {v}^{′}}^{2} ) + P ( {V}_{1} ∉ {I}_{v , {v}^{′}} {∩V}_{2} ∈ {I}_{v , {v}^{′}} ) {\{ P ( {V}_{1} ∈ {I}_{v , {v}^{′}} ) > 0 )}_{} ( v , {v}^{′} ) + P ( {V}_{1} ∈ {I}_{v , {v}^{′}} {∩V}_{2} ∉ {1}_{v , {v}^{′}} ) {\{ P ( {V}_{2} ∈ {I}_{v , {v}^{′}} ) > 0 )}_{} ( v , {v}^{′} )$$

which can be rewritten, thanks to the independence of the two movement speed densities of the mobile terminal V₁ and V₂, in the form:

$$P ( V ∈ {I}_{v , {v}^{′}} ) = ( 1 - P ( {V}_{1} ∉ {I}_{v , {v}^{′}} ) P ( {V}_{2} ∉ {I}_{v , {v}^{′}} ) ) {\{ P ( {V}_{1} ∈ {I}_{v , {v}^{′}} ∩ {V}_{2} ∈ {I}_{v , {v}^{′}} ) > 0 )}_{} ( v , {v}^{′} ) \qquad ( 4 )$$

Such an expression can easily be generalised to n independent mobile terminal movement speed densities, where n corresponds to the number of event pairs Cᵢ constituted for a given time window.

Equation (4) can then be normalised to verify the following property: (V ∈ [symbol] ₊)=1 which means that the average movement speed of the mobile terminal being searched for is positive or null.

In some embodiments, from the average movement speed density of the mobile terminal as determined for example above, it is possible to obtain, in a step H4, a value of an average movement speed of the mobile terminal by calculating the expectation of a probability law associated with the average movement speed density of the mobile terminal V.

In this way, a 95% confidence interval can be determined, for example, to obtain a value for the average movement speed of the mobile terminal over the time window considered. Naturally, other methods of determining a value for the average movement speed of the mobile terminal over the time window considered can be implemented in some embodiments, such as calculating the median.

In some embodiments, to mitigate the phenomenon of network oscillation, the times tᵢ and tⱼ corresponding respectively to a network event ERᵢ and to an event ERⱼ constituting a pair Cᵢ of network events, can be chosen to be separated by a minimum duration. This means that the time elapsed between the occurrence of the event ERᵢ and the event ERⱼ is greater than or equal to a first duration. Such a duration, acting as a threshold, can for example, when the time window considered lasts 15 minutes, be set in the order of a few seconds to a few minutes (for example 3 to 9 minutes), such as a duration of 5 or 6 minutes. Naturally, other values of this first duration can be envisaged.

In a third implementation, the transition probability P(s₂|s₁) is determined as follows:

P(s₂/51 s₁)=∫_{θ}_{ₘᵢₙ} ^{θ}^{ₘₐₓ}f(θ)dθ
in which s₁ represents the first candidate route segment within the coverage area of said first base station, s₂ represents the second candidate route segment within the coverage area of said second base station, f (θ) represents an average direction density of movement of the mobile terminal between the coverage areas of the first base station A₁ and the second base station A₂, θₘᵢₙ, represents the infimum of an intersection of a first angular sector defining possible directions of movement for the mobile terminal with a second angular sector defining a maximum angle between a first end of the first candidate route segment and a second end of the second candidate route segment, and θₘₐₓ represents the supremum of the intersection of the first angular sector and the second angular sector. More specifically, the first angular interval defines a 95% confidence interval for the estimated direction of the mobile terminal. The second angular sector can also be defined as the angular sector between the supremum and the infimum of the four angles formed by the lines connecting the ends of the first candidate route segment s₁ and the ends of the second candidate route segment s₂.

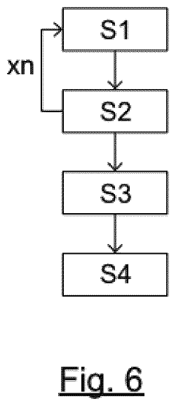

With reference to FIG. 6, the variable representing a movement of the mobile terminal is the movement direction.

Since obtaining a value for the movement direction of a mobile terminal relies on the use of signalling data relating to mobile terminals, and therefore to their users, it may be necessary to comply with constraints on anonymisation, or pseudoanonymisation, in the short term. Hence, the calculations to be performed use signalling data whose history does not exceed a certain duration. Such as duration is 15 minutes, for example.

In order to determine the value of a movement direction of a mobile terminal, in a step S1, a first network event ER1 and a second network event ER2 are selected from a plurality of network events ERᵢ involving the mobile terminal.

The first and second network events ER1, ER2 occur respectively at times t₁ and t₂ and involve the antennas A₁ and A₂ carried by two different base stations.

For i ∈ {1, 2} we denote (Xᵢ, Yᵢ) the random variables respectively giving the longitude and latitude of the mobile terminal at time tᵢ.

In a step S2, a direction density f_{θ}_{₁₂}, is determined. By using the total probability formula and the hypotheses mentioned above, it can be proved directly that the pair of variables (Xᵢ, Yᵢ) follows a density law fᵢ.

It is then posed

$${θ}_{12} = arctan ( \frac{{Y}_{2} - {Y}_{1}}{{X}_{2} - {X}_{1}} )$$

where θ₁₂ is the random variable giving the movement direction of the mobile terminal between the times t₁ and t₂.

The random variable θ₁₂ follows a density law f_{θ}_{₁₂}, such that: ∀ θ ∈ [0, 2π[:

$${f}_{{θ}_{12}} ( θ ) = {\int }_{{R}^{3}} {f}_{1} ( {x}_{1} , {y}_{1} ) {f}_{2} ( {x}_{2} , {y}_{1} + ( {x}_{2} - {x}_{1} ) tan ( θ ) ) ( {x}_{2} - {x}_{1} ) ( 1 + {tan}^{2} ( θ ) ) {\{ {x}_{2} \neq {x}_{1} \}}_{} {\{ θ \neq ( k + \frac{1}{2} ) π , k ε ℤ \}}_{} {dx}_{1} {dx}_{2} {dy}_{1}$$

Since the mobile terminal is assumed to move in a uniform rectilinear motion, a direction density is calculated as follows:

By integrating this density over an angle interval [θₐ, θ_{b}] included in

$$[ 0 , 2 π [ ∖ \{ ( k + \frac{1}{2} ) π , k ε ℤ \}$$

and noting E(θₐ, θ_{b})={(x, y, x′, y′) ∈ [symbol] ⁴−y′ϵ[y+(x′−x)tan(θₐ), (x′−x)tan(θ_{b})]}, it is obtained, after inversion and with the help of changes of variables y₂=y₁+(x₂−x₁)tan(θ) in the appropriate integrals, we obtain a form that is much more convenient for numerical calculation:

∫₇₄ _{ₐ}^{θ}^{_{b}}f_{θ}_{₁₂}(θ)= [symbol] f₁(x₁, y₁)f₂(x₂, y₂) [symbol] _{E(θ}_{ₐ}_{,θ}_{_{b}}⁾(x₁, x₂, y₁, y₂)dx₁dx₂dy₁dy₂ (2)

Thus, at the end of step S2, a direction density f_{θ}_{₁₂} is obtained for a pair of network events ER1, ER2.

In order to improve the accuracy of the value of the mobile terminal movement direction, steps S1 and S2 can be repeated for a plurality of pairs of events on the condition that the times tᵢ associated with each event fall within the time window of 15 minutes defined above.

Hence, once all the pairs of events ERᵢ, ERⱼ within the time window have been formed, steps S1 and S2 can be carried out for each of these pairs of events ERᵢ, ERⱼ. At the end of these various iterations of steps S1 and S2, as many mobile terminal movement speed densities are obtained as there are pairs of events ERᵢ, ERⱼ.

In a step S3, the different movement direction densities of the mobile terminal obtained can be combined. The result of such a combination is a probability density of the average movement direction of the mobile terminal over the duration of the time window considered.

To achieve this, a further assumption needs to be added. Hence, it is assumed that there is a direction law relating to the movement of the mobile terminal. It is assumed that this direction law relating to the movement of the mobile terminal can be obtained from the different movement direction densities of the mobile terminal corresponding to the pairs of events ERᵢ, ERⱼ.

To obtain the probability density of the average movement direction of the mobile terminal over the duration of the time window considered, two pairs of events are considered, a first pair of events C₁ constituted by events ER1 and ER2 and a second pair of events C₂ constituted by events ER3 and ER4, as well as the corresponding movement direction densities of the mobile terminal obtained at the end of the implementation of steps S1 and S2, and noted respectively θ₁ and θ₂.

Note θ the random variable representing the average movement direction density of the mobile terminal, which it is sought to be obtained from the movement direction densities of the mobile terminal θ₁ and θ₂.

Knowing the following property:

∀(θ, θ′)∈ [symbol] ₊², P(θ ∈ [θ, θ′])>0⇔P(θ₁ ∈ [θ,θ′])>0) et P(θ₂ ∈ [θ, θ′])>0) (3)
which says that for the event, in the sense of probabilities, “θ ∈ [θ, θ′]” occurs with a non-null probability, it is necessary and sufficient that the events, in the sense of probabilities, “θᵢ ∈ [θ, θ′]” occur with a non-null probability.

By noting that the movement direction densities of the mobile terminal θ₁ and θ₂ are independent of each other by construction, property (3) can then be rewritten as:

∀(θ, θ′)∈ [0,2π[², P(θ ∈ [θ, θ′])>0⇔P(θ₁>0∩θ₂>0)>0 (3′)

If we consider the average direction density of the mobile terminal θ verifying equation (3′) as the result of two random experiments whose order does not matter, it is then possible to write, by noting I_{θ,θ′}=[θ, θ′] for all θ, θ′:

$$P ( θ ∈ {I}_{θ , {θ}^{′}} ) = P ( {θ}_{1} , {θ}_{2} ∈ {I}_{θ , {θ}^{′}}^{2} ) + P ( {θ}_{1} ∉ {I}_{θ , {θ}^{′}} {∩θ}_{2} ∈ {I}_{θ , {θ}^{′}} ) {\{ P ( {θ}_{1} ∈ {I}_{θ , {θ}^{′}} ) > 0 \}}_{} ( θ , {θ}^{′} ) + P ( {θ}_{1} ∈ {I}_{θ , {θ}^{′}} {∩θ}_{2} ∉ {I}_{θ , {θ}^{′}} ) {\{ P ( {θ}_{2} ∈ {I}_{θ , {θ}^{′}} ) > 0 \}}_{} ( θ , {θ}^{′} )$$

which can be rewritten, thanks to the independence of the two movement direction densities of the mobile terminal θ₁ and θ₂, in the form:

$$P ( θ ∈ {I}_{θ , {θ}^{′}} ) = ( 1 - P ( {θ}_{1} ∉ {I}_{θ , {θ}^{′}} ) P ( {θ}_{2} ∉ {I}_{θ , {θ}^{′}} ) ) {\{ P ( {θ}_{1} ∈ {I}_{θ , {θ}^{′}} {∩θ}_{2} ∈ {I}_{θ , {θ}^{′}} ) > 0 \}}_{} ( θ , {θ}^{′} ) \qquad ( 4 )$$

Such an expression can easily be generalised to n independent mobile terminal movement direction densities, where n corresponds to the number of event pairs C, constituted for a given time window.

In some embodiments, equation (4) can then be normalised to verify the following property: P(θ ∈ [0, 2π[)=1, which means that the average movement direction of the mobile terminal being searched for is in the interval [0, 2π[.

In some embodiments, from the average movement direction density of the mobile terminal thus determined, it is possible to obtain, in a step S4, a value of an average movement direction of the mobile terminal by calculating the expectation of a probability law associated with the average movement direction density of the mobile terminal θ.

Insofar as the direction densities of the mobile terminal are circular densities, the calculation of the expectation and standard deviation must be adapted.

To do this, it is necessary to set: m₁=∫_{Γ}P(θ)e^{iθ}dθ, where Γ is any interval of range 2 π.

The average movement direction of the mobile terminal is then expressed as θ̅=arg (m₁).

There are several possible methods for calculating the standard deviation, most often using the modulus of m₁ and an analogy with a circular normal distribution. In an example, the following estimator of the standard deviation is given by:

$${σ}_{θ} = arcsin ( ε ) [ 1 + ( \frac{2}{\sqrt{3}} - 1 ) {ε}^{3} ]$$

where ϵ={square root over (1−(Re(m₁)²+Im(m₁)²))} where Re(m1) and Im(m1) denote the real part and imaginary part of m1 respectively.

This standard deviation can then be used to determine a 95% confidence interval.

In this third implementation, a first angular sector is defined as extending between a first direction θ_{model max} associated with one of the candidate segments associated with the event E2 and a direction θ_{model min} associated with another of the candidate segments associated with the event E2, the directions of the other candidate route segments being comprised between θ_{model max} and θ_{model min}.

A second angular sector is defined as extending between a first direction θ_{trans max} associated with a segment connecting a first end of a candidate segment associated with the event E1 and a first end of a candidate segment associated with the event E2, and a direction θ_{trrans min} associated with another segment connecting a second end of a candidate segment associated with the event E1 and a second end of a candidate segment associated with the event E2. The directions of the other segments connecting the ends of the two candidate segments associated respectively with the event E1 and the event E2 are comprised between θ_{trans max} and θ_{trans min}.

Of course, the transition probability P(s₂|s₁) can be determined as a function of at least two densities representative of a movement of the mobile terminal from among the distance distribution density between the coverage areas of the first base station and the second base station f(u), the average movement speed density of the mobile terminal f(ν) and the average movement direction density of the mobile terminal between the coverage areas of the first base station and the second base station f (θ).

To take into account the behaviour of the mobile terminal user, the transition probability can be weighted, in some embodiments, by means of a penalty coefficient representative of the number of nodes of a transport network comprised in a candidate route. A node in a transport network is, for example, a crossroads, an underground station, a railway station, etc. It is based on the principle that a user seeks to limit (for example, minimise) changes of direction or mode of transport and therefore the number of nodes in the candidate route.

By way of example, the mathematical law linking the value of the penalty coefficient with the number of nodes is given by the following formula:

y=λe^{-λx}
where y corresponds to the value of the penalty coefficient, x to the number of nodes −1 and λ a constant. In the remainder of this document, it is assumed that λ is 1. Naturally, λ can take other values depending on the case in question.

At the end of step G4, a transmission probability has been calculated for all the candidate route segments for a given network event pair.

Steps G3 and G4 are implemented, for example, for all the network events considered for determining the route taken by the mobile terminal.

Hence, once steps G3 and G4 have been implemented for all the network events considered for determining the route taken by the mobile terminal, a plurality of candidate routes are available for the mobile terminal.

In a step G5, the route taken by the mobile terminal is selected from the set of candidate routes, taking into account the connection (or transmission) probabilities and the transition probabilities of the plurality of network events considered. For example, the selected route taken may be the one for which a product of the set of connection (or transmission) probabilities with the set of transition probabilities determined for the plurality of network events considered is the highest. To achieve this, for example, a Viterbi algorithm can be applied to choose the most likely route from a set of candidate routes.

In some embodiments, a mobile terminal mobility detection algorithm can be used to obtain only data relating to mobile terminals that are indeed moving. Indeed, determining the itinerary of a mobile terminal that is not indeed moving may, in some embodiments, be of little interest (or no interest) and accounting for immobile terminals can make it possible to limit the load in terms of memory and processing resources required to execute the process.

In such an embodiment, to estimate the effective mobility of a mobile terminal, the distance travelled or the direction of a mobile terminal can be used, for example.

To achieve this, for example, the same operations as described above with reference to FIG. 4 can be applied to a second pair of network events ER3 and ER4 belonging to the second set of network events JER2 in order to obtain a distance density f_{D}_{₃₄} covered for the pair of network events ER3, ER4. The network events ER3 and ER4 occur within the same cell.

Hence, in some embodiments, at the end of a step E2′, a first distance density f_{D}_{₁₂} travelled for the pair of events ER1, ER2 and a second distance density f_{D}_{₃₄} travelled for the pair of network events ER3, ER4 can be obtained.

This second distance density f_{D}_{₃₄} travelled represents an uncertainty of movement of the mobile terminal inherent in the radio communication network, which will make it possible to determine whether the first distance density f_{D}_{₁₂} travelled corresponds to an (actual) movement of the mobile terminal or corresponds to an immobile mobile terminal from the point of view of the radio communications network, that is a mobile terminal that has stayed within the coverage area of the same base station.

To improve the accuracy of the value of the distance travelled by the mobile terminal, and/or the accuracy of the value of the uncertainty of movement of the mobile terminal inherent in the radio communication network, steps E1′ and E2′ (which correspond to steps E1 and E2 described with reference to FIG. 4) can be repeated, in certain embodiments, for a plurality of pairs of network events belonging to the first set of network events JER1 and/or for a plurality of pairs of network events belonging to the second set of network events JER2 (on the condition, for example, that the times tᵢ associated with each of the events are comprised within the time window (of 15 minutes, for example) defined above). Naturally, the length of the time window can take on any other value according to embodiments (for example, depending on requirements, legislation, etc.)

Thus, once all the pairs of events ERᵢ, ERⱼ taken within the time window have been constituted for the two sets of network events JER1 and JER2, steps E1′ and E2′ can be implemented for pairs of events ER,ᵢ, ERⱼ from one of these two sets of network events JER1 and JER2 (for each of these pairs from these two sets, for example). At the end of these various iterations of steps E1′ and E2′, it is possible to obtain, for the first set of network events JER1, as many distances densities travelled by the mobile terminal as there are pairs of events ERᵢ, ERⱼ originating from this set of network events JER1 and, for the second set of network events JER2, as many values of an uncertainty of movement of the mobile terminal inherent in the radio communication network as there are pairs of events ERᵢ, ERⱼ originating from this set of network events JER2.

In some embodiments, a step E3′ (which corresponds to step E3 and E2 described with reference to FIG. 4) during which a combination between them of the different distance densities travelled by the mobile terminal obtained for the pairs of network events belonging to the first set of network events JER1 can be implemented. Such a combination may, for example, result in an average travelled distance density of the mobile terminal for a duration less than or equal to that of the time window considered.

Such embodiments may, for example, be based on an additional assumption. Hence, it can be assumed that there is a distance travelled law relating to the movement of the mobile terminal. For example, it can be assumed that this distance travelled law relating to the movement of the mobile terminal can be obtained from the different distance travelled densities of the mobile terminal corresponding to the pairs of events ERᵢ, ERⱼ.

In the detailed embodiments, to obtain the density of the average movement distance travelled density of the mobile terminal over the duration of the time window considered, it is possible, for example, to consider two pairs of events belonging to the first set of network events JER1, a first pair of events C₁ constituted by events ER1 and ER2 and a second pair of events C₂ constituted by events ER5 and ER6, as well as the corresponding movement distance travelled densities of the mobile terminal obtained at the end of the implementation of steps E1 and E2, and noted respectively D₁ and D₂.

Note D the random variable representing the average movement distance travelled density of the mobile terminal, which it is sought to be obtained from the movement distance travelled densities of the mobile terminal D₁ and D₂.

Knowing the following property:

∀(d, d′) ∈ [symbol] ₊², P(D ∈ [d, d′])>0⇔P(D₁ ∈ [d, d′])>0) et P(D₂ ∈ [d, d′])>0) (3)
which says that for the event, in the sense of probabilities, “D ∈ [d, d′]” occurs with a non-null probability, it is necessary and sufficient that the events, in the sense of probabilities, “Dᵢ ∈ [d, d′]” occur with a non-null probability.

By noting that the distance travelled densities of the mobile terminal VD₁ and D₂ are independent of each other by construction, property (3) can then be rewritten as:

∀(d, d′) ∈ [symbol] ₊², P(D ∈ [d, d′])>0⇔P(D₁>0∩D₂>0)>0 (3′)

If we consider the average distance travelled density of the mobile terminal D verifying equation (3′) as the result of two random experiments whose order does not matter, it is then possible to write, by noting I_{d,d′}=[d, d′] for all d, d′:

$$( D ∈ {I}_{d , {d}^{′}} ) = P ( {D}_{1} , {D}_{2} ∈ {I}_{d , {d}^{′}}^{2} ) + P ( {D}_{1} ∉ {I}_{d , {d}^{′}} ∩ {D}_{2} ∈ {I}_{d , {d}^{′}} ) {\{ P ( {D}_{1} ∈ {I}_{d , {d}^{′}} ) > 0 \}}_{} ( d , {d}^{′} ) + P ( {D}_{1} ∈ {I}_{d , {d}^{′}} ∩ {D}_{2} ∉ {I}_{d , {d}^{′}} ) {\{ P ( {D}_{2} ∈ {I}_{d , {d}^{′}} ) > 0 \}}_{} ( d , {d}^{′} )$$

which can be rewritten, thanks to the independence of the two distance densities travelled by the mobile terminal D₁ and D₂, in the form:

$$P ( D ∈ {I}_{a , {a}^{′}} ) = ( 1 - P ( {D}_{1} ∉ {I}_{d , {d}^{′}} ) P ( {D}_{2} ∉ {I}_{d , {d}^{′}} ) ) {\{ P ( {D}_{1} ∈ {I}_{d , {d}^{′}} ) > 0 \}}_{} ( d , {d}^{′} ) \qquad ( 4 )$$

Such an expression can easily be generalised to n independent distance densities travelled by the mobile terminal, where n corresponds to the number of event pairs Cᵢ constituted for a given time window.

Equation (4) can then be normalised to verify the following property:

P(V ∈ [symbol] ₊)=1
which means that the average distance travelled by the mobile terminal being searched for is positive or null.

The same reasoning can be applied to obtain a combination between them of the different values of an uncertainty of movement of the mobile terminal inherent in the radio communication network obtained for the pairs of network events belonging to the second set of network events JER2.

As previously, two pairs of events are considered, belonging to the second set of network events JER2, a first pair of events C₃ constituted by events ER3 and ER4 and a second pair of events C₄ constituted by events ER7 and ER8, as well as the corresponding movement distance travelled densities of the mobile terminal obtained at the end of the implementation of steps E1′ and E2′, and noted respectively D₃ and D₄. A random variable D′ is then obtained representing an uncertainty of movement of the mobile terminal inherent in the average radio communication network.

In some embodiments, it is possible, for example, to compare the first density of distance travelled by the mobile terminal, obtained from pairs of events belonging to the first set of network events JER1, with this noise information, obtained from pairs of events belonging to the second set of network events JER2, in order to determine whether the mobile terminal has indeed moved, i.e. has changed its home base station consecutively to an (actual) move, or whether the mobile terminal has not left the coverage area of a base station and is therefore immobile from the point of view of the radio communications network.

In some embodiments, in order to compare the first density of distance travelled and the second density of distance travelled, a Hellinger distance, for example, is determined in a step E4. Such a Hellinger distance can be constructed from a Bhattacharyya coefficient.

As explained in more detail below, the value of the Hellinger distance constructed in this way can help determine whether the mobile terminal has indeed moved. When the Helliger distance has a high value, that is when it is close to 1, the mobile terminal is considered to have indeed moved. When the Helliger distance has a low value, that is when it is close to 0, the mobile terminal is considered to be immobile. Thus, for continuous probability densities p and q, the Bhattacharyya coefficient is defined as: BC(p, q)=∫\sqrt{p(x)q(x)dx}.

Such a Bhattacharyya coefficient lies between 0, where the continuous probability densities p and q do not overlap, and 1, where the continuous probability densities p and q are equal.

The Hellinger distance is then defined as: d_{H}(p, q)=\sqrt{1−BC(p, q)}.

This distance also lies between 0, where the continuous probability densities p and q do not overlap, and 1, where the continuous probability densities p and q are equal.

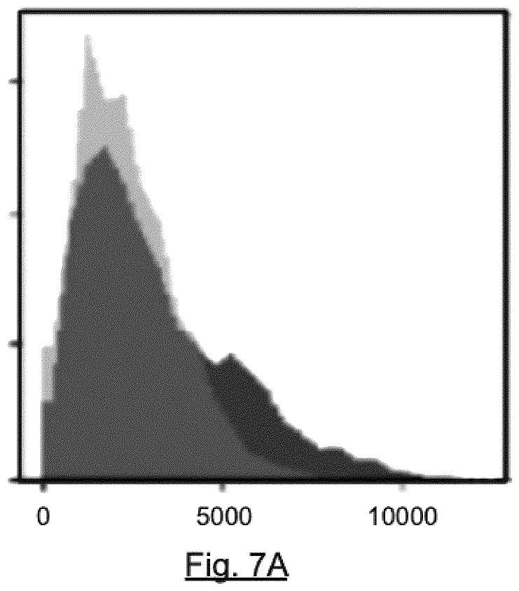

FIG. 7A and FIG. 7B respectively show a situation in which the mobile terminal is immobile from the point of view of the radio communications network and a situation in which the mobile terminal is mobile from the point of view of the radio communications network.

FIG. 7A indeed shows that the two densities of distance travelled overlap almost completely, corresponding to a Hellinger distance close to 0. In FIG. 4B, on the other hand, it is seen that the two densities of distance travelled do not overlap, corresponding to a Hellinger distance close to 1.

In some embodiments, to mitigate the phenomenon of network oscillation, the times tᵢ and tⱼ corresponding respectively to a network event ER, and to an event ERS constituting a pair Cᵢ of network events, can be chosen to be separated by a minimum duration. Thus, the duration elapsed between the occurrence of the event ER, and the event ERS is greater than or equal to a first duration. Such a duration, acting as a threshold, can for example, when the time window considered lasts 15 minutes, be set in the order of a few minutes (for example 3 to 9 minutes), such as a duration of 6 minutes. Naturally, other values of this first duration can be envisaged.

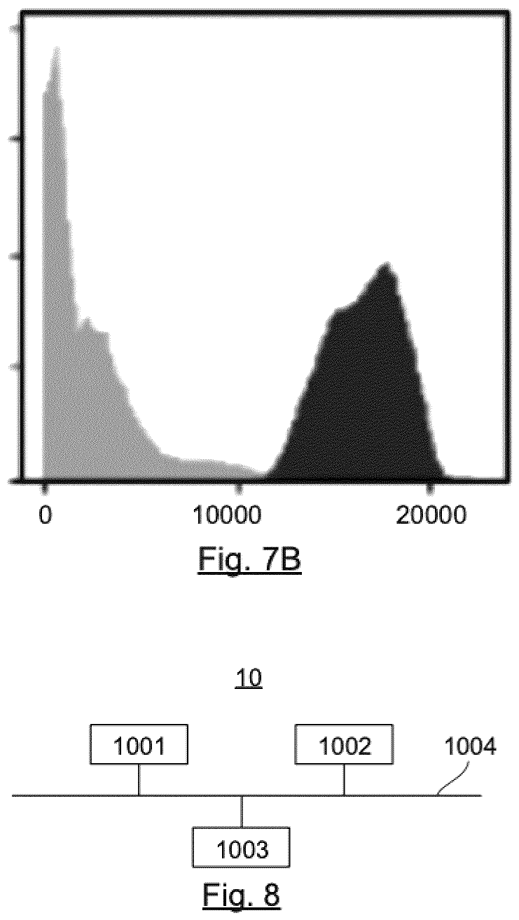

FIG. 8 illustrates a device 10 capable of implementing certain steps of the previously described solution.

A device 10 may comprise at least one hardware processor 1001, a storage unit 1002 and an interface 1003, which are connected to each other via a bus 1004. Naturally, the components of the device 10 can be connected by means of a connection other than a bus.

The processor 1001 controls the operations of the device 10. The storage unit 1002 stores at least one program for implementing the method covered by the development to be executed by the processor 1001, and various data, such as parameters used for calculations performed by the processor 1001, intermediate data for calculations performed by the processor 1001, etc. The processor 1001 may be formed by any known and appropriate hardware or software, or by a combination of hardware and software. For example, the processor 1001 can be formed by a dedicated hardware such as a processing circuit, or by a programmable processing unit such as a Central Processing Unit which executes a program stored in a memory thereof.

The storage unit 1002 may be formed by any appropriate means capable of storing the program or programs and data in a computer-readable manner. Examples of storage devices 1002 include non-transitory computer-readable storage media such as semiconductor memory devices, and magnetic, optical or magneto-optical recording media loaded into a read/write device.

Interface 1003 provides an interface between device 10 and other equipment in the radio communication network.

1. A method of determining a route of a mobile terminal from data relating to a plurality of network events involving the mobile terminal, the route comprising at least one route segment of a transport network, the method comprising:
determining at least one candidate route during which it is determined, for at least one first network event from the plurality of network events:
a probability of connection of the mobile terminal to a first base station involved in the first network event, knowing that the mobile terminal is located, at a time t1 at which the first network event occurred, on a first candidate route segment located in a coverage area of the first base station, and/or
a probability of transition, at a time t2 at which a second network event in which a second base station is involved has occurred, of the terminal to at least one second candidate route segment located in a coverage area of the second base station, knowing that the mobile terminal is on the first candidate route segment at time t1; and
selecting the route of the mobile terminal from the set of candidate routes, taking account of the connection probabilities and transition probabilities determined for the plurality of network events.

2. The method of determining a route according to claim 1, wherein the selected route is the one for which a product of the set of connection probabilities with the set of transition probabilities determined for the plurality of network events considered is the highest.

3. The method of determining a route according to claim 1, wherein the connection probability P(A|s₁) for a given network event is determined according to the following formula:
$$P ( A \vert {s}_{1} ) = \frac{{\sum }_{j = 1}^{n} P ( A \vert {p}_{j} )}{n}$$
in which A represents the first base station involved in the first event, s₁ represents the first candidate route segment located within the coverage area of the first base station, pⱼ represents a pixel of a likelihood map representing a probability of connection of the mobile terminal to the first base station when the terminal is located on a pixel of the likelihood map, and n represents the number of pixels of the likelihood map of non-null weight crossed by the first candidate route segment

4. The method of determining a route according to claim 3, comprising a selection of the at least one first candidate route segment by taking into account a distance between the at least one first candidate route segment and at least one candidate route segment at a time t0 prior to a time t1.

5. The method of determining a route according to claim 4, wherein the at least one first candidate route segment is selected among the route segments located at a distance less than or equal to a first distance, so-called connectivity tolerance distance, from all the candidate route segments at the time t0 prior to the time t1.

6. The method of determining a route according to claim 4, wherein the value of the first connectivity tolerance distance takes into account a geographic distribution density of base stations and a median radius of a base station coverage area in the vicinity of said the first base station.

7. The method of determining a route according to claim 1, wherein the connection probability is weighted according to a deviation of a direction of the first candidate route segment from a reference direction.

8. The method of determining a route according to claim 1, wherein the transition probability P (s₂|s₁) for a given network event is determined according to the following formula:
P(s₂/51 s₁)=∫_{d}_{ₘᵢₙ} ^{d}^{ₘₐₓ}f(u)du
in which: s₁ represents the first candidate route segment within the coverage area of the first base station, s₂ represents the second candidate route segment within the coverage area of the second base station, f (u) represents a distance distribution density between the coverage areas of the first base station and the second base station, dₘᵢₙ represents the minimum distance separating the first candidate route segment and the second candidate route segment on a graph representing the transport network, and d max represents the sum of dₘᵢₙ with the length of the first candidate route segment and the length of the second candidate route segment.

9. The method of determining a route according to claim in which wherein the transition probability is determined by taking into account a distribution density of distances between the coverage areas of the first base station and the second base station.

10. The method of determining a route according to claim 1, wherein the transition probability P(s₂|s₁) for a given network event is determined according to the following formula:
P(s₂/51 s₁)=∫_{ν}_{ₘᵢₙ} ^{ν}^{ₘₐₓ}f(ν)dν
in which s₁ represents the first candidate route segment within the coverage area of the first base station, s₂ represents the second candidate route segment within the coverage area of the second base station, f (ν) represents an average speed density of movement of the mobile terminal, νₘᵢₙ=dₘᵢₙ/Δt where dₘᵢₙ represents the minimum distance separating the first candidate route segment and the second candidate route segment on a graph representing the transport network and νₘₐₓ=dₘₐₓ/Δt where dₘₐₓ represents the sum of dₘᵢₙ with the length of the first candidate route segment and the length of the second candidate route segment and where Δt=t1−t2.

11. The method of determining a route according to claim 1, wherein the transition probability P(s₂|s₁) for a given network event is determined according to the following formula:
P(s₂/51 s₁)=∫_{θ}_{ₘᵢₙ} ^{θ}^{ₘₐₓ}f(θ)dθ
in which s₁ represents the first candidate route segment within the coverage area of the first base station, s₂ represents the second candidate route segment within the coverage area of the second base station, f (θ) represents an average direction density of movement of the mobile terminal between the coverage areas of the first base station and the second base station, θₘᵢₙ represents the infimum of an intersection of a first angular sector defining possible directions of movement for the mobile terminal with a second angular sector defining a maximum angle between a first end of the first candidate route segment and a second end of the second candidate route segment, and θₘₐₓ represents the supremum of the intersection of the first angular sector and the second angular sector.

12. The method of determining a route according to claim 6, wherein the transition probability is determined as a function of at least two densities representative of a movement of the mobile terminal from among the distribution density of distances between the coverage areas of the first base station and the second base station f (u), the average movement speed density of the mobile terminal f (ν) and the average movement direction of the mobile terminal between the coverage areas of the first base station and the second base station f (θ).

13. The method of determining a route according to claim 6, wherein the transition probability is weighted according to the number of intersections of route segments of the transport network encountered along the candidate route.

14. The method of determining a route according to claim 6, wherein the transition probability is weighted by a penalty coefficient representative of a number of intersections of route segments of the transport network encountered along the candidate route, the penalty coefficient tending towards zero as the number of intersections increases.

15. A device for determining a route for a mobile terminal from data relating to a plurality of network events involving the mobile terminal, the route comprising at least one route segment of a transport network, the device comprising at least one processor configured to:
determine at least one candidate route by determining, for at least one first network event from the plurality of network events:
a probability of connection of the mobile terminal to a first base station involved in the first network event, knowing that the mobile terminal is located, at a time t1 at which the first network event occurred, on a first candidate route segment located in a coverage area of the first base station, and/or
a probability of transition, at a time t2 at which a second network event in which a second base station is involved has occurred, of the terminal to at least one second candidate route segment located in a coverage area of the second base station, knowing that the mobile terminal is on the first candidate route segment at the time t1; and
select the route taken from the set of candidate routes, the route taken being the one for which a product of the set of connection probabilities with the set of transition probabilities determined for the plurality of network events is the highest.

16. The device for determining a route according to claim 15, said wherein the selected route is the one for which a product of the set of connection probabilities with the set of transition probabilities determined for the plurality of network events considered is the highest.

17. The device for determining a route according to claim 15, wherein the connection probability P(A|s₁) for a given network event is determined according to the following formula:
$$P ( A \vert {s}_{1} ) = \frac{{\sum }_{j = 1}^{n} P ( A \vert {p}_{j} )}{n}$$
in which A represents the first base station involved in the first event, s₁ represents the first candidate route segment located within the coverage area of the first base station, pⱼ represents a pixel of a likelihood map representing a probability of connection of the mobile terminal to the first base station when the terminal is located on a pixel of the likelihood map, and n represents the number of pixels of the likelihood map of non-null weight crossed by the first candidate route segment s₁.

18. The device for determining a route according to claim 17, wherein the at least one processor is configured to select the at least one first candidate route segment by taking into account a distance between the at least one first candidate route segment and at least one candidate route segment at a time t0 prior to the time

19. The device for determining a route according to claim 18, wherein the at least one first candidate route segment is selected among the route segments located at a distance less than or equal to a first distance, so-called a connectivity tolerance distance, of all the candidate route segments at the time t0 prior to the time t1.

20. A non-transitory computer-readable storage medium on which is stored a computer program comprising program code instructions for implementing the method according to claim 1.
